(19) United States
(12) Patent Application Publication
(10) Pub. No.: US 2013/0069884 A1
(43) Pub. Date: Mar. 21, 2013

(54) TOUCH-SENSING DISPLAY PANEL

(71) Applicants: Yi-Ru Cheng, Hsinchu County (TW); Ya-Ling Hsu, New Taipei City (TW)

(72) Inventors: Yi-Ru Cheng, Hsinchu County (TW); Ya-Ling Hsu, New Taipei City (TW)

(73) Assignee: Au Optronics Corporation, Hsinchu (TW)

(21) Appl. No.: 13/304,708

(22) Filed: Nov. 28, 2011

(30) Foreign Application Priority Data
Sep. 15, 2011 (TW) 100133226

(51) Int. Cl. G06F 3/041

(52) U.S. Cl. 345/173

(57) ABSTRACT

A touch-sensing display panel includes display units, touch-sensing units, a gate driver circuit, a data driver circuit, and readout circuits. Each display unit includes a switching element, a gate line, a data line, and a pixel electrode. The switching element is connected to the gate line, the data line, and the pixel electrode. The touch-sensing units includes a first, a second, and a third touch-sensing units. Each touch-sensing unit includes a sensing element and a sensing line electrically connected to the sensing element. The gate driver circuit is electrically connected to the gate line. The data driver circuit is connected to the data line. The readout circuit includes adjacent first and second readout circuits. The sensing line of the first touch-sensing unit is connected to the first readout circuit. The sensing line of the second touch-sensing unit is connected to the first and the second readout circuits simultaneously.

### CROSS-REFERENCE TO RELATED APPLICATION

This application claims the priority benefit of Taiwan application serial no. 100133226, filed on Sep. 15, 2011. The entirety of the above-mentioned patent application is hereby incorporated by reference herein and made a part of this specification.

### BACKGROUND OF THE INVENTION

1. Technical Field

The invention relates to a touch-sensing display panel, more particularly to a touch-sensing display panel using a differential signal for calculating the touched position.

2. Background

The advancement of display technology renders people's life more convenient with the assistance of display apparatus. Flat panel displays (FPD) have gradually become the mainstream products in the display market due to their light-and-thin characteristics. Recently, various types of electronic products are developed along the line of easy operation, small volume, and large screen size. The requirements on the volume and the screen size of portable products are particularly demanding. Accordingly, a touch-sensing design and a liquid crystal display panel are integrated in many electronic products so that the space for disposing a keyboard or an operation button can be eliminated. Hence, the space available for disposing a screen can be enlarged.

Generally speaking, a touch-sensing display panel includes a plurality of display units and a plurality of touch-sensing units, wherein the plurality of display units forms a display panel, and the plurality touch-sensing units is constructed internally in the display panel or forms a touch-sensing panel externally attached to the display panel. Currently, the touch-sensing units are categorized into, according to the different sensing methods, resistance touch-sensing units, capacitance touch-sensing units, photo-touch-sensing units, sound wave touch-sensing units, and electromagnetic touch-sensing units. When a user uses a finger or a stylus to contact the touch-sensing display panel, an electrical change, for example, a change in the capacitance, current, or resistance, etc., is generated at the touched position of the touch-sensing unit. This type of electrical change is converted to an electronic signal, and subsequent to an calculation operation, an appropriate command for operating the electronic device is outputted.

In order to determine an electrical change in the touch-sensing units, a differential driving integrated circuit chip is used to perform a calculation on the read signal difference between the adjacent touch-sensing units. At the point where there is a change in the signal difference, which is calculated by the differential driving integrated circuit chip, it is determined to be the point where the touching occurs. However, when a plurality of differential driving integrated circuit chips are used to perform the above operation, these touch-sensing units may be connected to different differential driving integrated circuit chips through different transmission structures (such as, circuit board, conducting wires layout, etc.). Accordingly, even the touch-sensing display panel is not being touched, the signals received by different differential driving integrated circuit chips may not be consistent. Hence, errors may easily occur during the signal difference calculation and erroneous touch sensing results are generated.

### SUMMARY

An exemplary embodiment of the invention provides a touch-sensing display panel having a desirable touch-sensing accuracy.

An exemplary embodiment of the invention provides a touch-sensing display panel, wherein the analyzed signals are read from the same readout circuit to provide a desirable sensing accuracy.

An exemplary embodiment of the invention provides a touch-sensing display panel that includes at least two display units, at least two touch-sensing units, at least a gate driver circuit, at least a data driver circuit, and at least two readout circuits. Each display unit includes at least a switching element, a gate line, a data line, and a pixel electrode. The switching element is connected to the gate line, the data line, and the pixel electrode. The at least two touch-sensing units include a first touch-sensing unit and a second touch-sensing unit. Each touch-sensing unit includes at least a sensing element and a sensing line, wherein the sensing element is electrically connected to the sensing line. The gate driver circuit is electrically connected to the gate line of each display unit. The data driver circuit is electrically connected to the data line of each display unit. The at least two readout circuits includes a first readout circuit and a second readout circuit configured adjacent to each other. The sensing line of the first touch-sensing unit is connected to the first readout circuit, the sensing line of the second touch-sensing unit is simultaneously connected to the first readout circuit and the second readout circuit.

According to an exemplary embodiment of the invention, each of the above readout circuits include a flexible circuit board. Further, the touch-sensing display panel further includes a rigid circuit board and at least a sensing integrated circuit, and the rigid circuit board is electrically connected to the flexible circuit of each readout circuit.

According to an exemplary embodiment of the invention, each of the above readout circuits include a flexible circuit board and at least a sensing integrated circuit.

According to an exemplary embodiment of the invention, each of the above touch-sensing units further includes a readout element and a storage capacitor connecting the readout element and the sensing element, and the readout element connects to the sensing line of each touch-sensing unit.

According to an exemplary embodiment of the invention, the above touch-sensing display panel further comprises a display medium configured on the pixel electrode, and the material of the display medium includes a non-self-luminescent material, a self-luminescent material, or a combination thereof.

According to an exemplary embodiment of the invention, the sensing element of each of the above touch-sensing units includes a resistance sensor, a capacitance sensor, a photosensor, a vibration sensor, electromagnetic sensor, or at least two of the above sensors.

Another exemplary embodiment of the invention provides a touch-sensing display panel that includes at least three display units, at least three touch-sensing units, at least a gate driver circuit, at least a data driver circuit, at least a reference touch-sensing unit, and at least three readout circuits. Each display unit includes a switching element, a gate line, a data line, and a pixel electrode. The switching element is connected to the gate line, the data line, and the pixel electrode. The at least three touch-sensing units includes a first touch-sensing unit, a second touch-sensing unit, and a third touch-sensing unit. Each touch-sensing unit at least includes a sensing element and a sensing line, wherein the sensing element is electrically connected to the sensing line. The at least gate driver circuit is electrically connected to the gate line of each display unit. The at least data driver circuit is electrically connected to the data line of each display unit. The at least reference touch-sensing unit includes at least a reference sensing element and a reference sensing line, and the reference sensing unit is electrically connected to the reference sensing line. The at least three readout circuits includes at first readout circuit, a second readout circuit and a third readout circuit configured adjacent to each other, wherein the sensing line of the first touch-sensing unit is electrically connected to the first readout circuit, the sensing line of the second touch-sensing unit is electrically connected to the second readout circuit, and the sensing line of the third touch-sensing unit is electrically connected to the third readout circuit. Further, the reference sensing line is concurrently connected to the first readout circuit, the second readout circuit, and the third readout circuit.

According to an exemplary embodiment of the invention, each of the above readout circuits includes a flexible circuit board. In one exemplary embodiment, the touch-sensing display panel further includes a rigid circuit board and at least a sensing integrated circuit, and the rigid circuit board electrically connected to the flexible circuit of each readout circuits.

According to an exemplary embodiment of the invention, each of the above readout circuits includes a flexible circuit board and a sensing integrated circuit.

According to an exemplary embodiment of the invention, each of the above touch-sensing units further includes a readout element and a storage capacitor connecting the readout element and the sensing element, and the readout element is connected to the sensing line of each touch-sensing unit.

According to an exemplary embodiment of the invention, the above touch-sensing display panel further includes a display medium disposed on the pixel electrode, and the material of the display medium includes a non-self-luminescent material, a self-luminescent material, or a combination thereof

According to an exemplary embodiment of the invention, the above sensing element includes a resistance sensor, a capacitance sensor, a photosensor, a vibration sensor, electromagnetic sensor, or at least two of the above sensors.

According to an exemplary embodiment of the invention, the sensing capability of the above reference sensing element is lower than that of each of the sensing element.

According to an exemplary embodiment of the invention, the differentiation of sensing signal values of the touch-sensing element approaches 0.

According to the exemplary embodiments of the invention, in the touch-sensing display panel, a plurality of touch-sensing units are connected to a plurality of readout circuits, and among these touch-sensing units, at least one thereof is concurrently connected to two adjacent readout circuits. With this kind of design, the touch-sensing panel is able to perform the signal analysis continuously on all the touch-sensing units. Further, the problem of signal inconsistency due to the different structural designs of the readout circuits or bonding processes is mitigated. Accordingly, the touch-sensing display panel of invention provides a desirable sensing accuracy.

The invention and certain merits provided by the invention can be better understood by way of the following exemplary embodiments and the accompanying drawings, which are not to be construed as limiting the scope of the invention.

### BRIEF DESCRIPTION OF THE DRAWINGS

FIG. 1 is a schematic diagram illustrating a touch-sensing display panel according to an exemplary embodiment of the invention.

FIG. 2 is a circuit diagram of a touch-sensing unit constructed with a photosensor according to an exemplary embodiment of the invention.

FIG. 3 illustrates a first layout method of a touch-sensing panel according to an exemplary embodiment of the invention.

FIG. 4 illustrates an implementation of an active region and a readout circuit in a touch-sensing display panel according to an exemplary embodiment of the invention.

FIG. 5 illustrates an implementation of an active region and a readout circuit in the touch-sensing display panel according to another exemplary embodiment of the invention.

FIG. 6 illustrates a layout method and a design between the active region and the readout circuit according to another exemplary embodiment of the invention.

### DETAILED DESCRIPTION OF DISCLOSED EMBODIMENTS

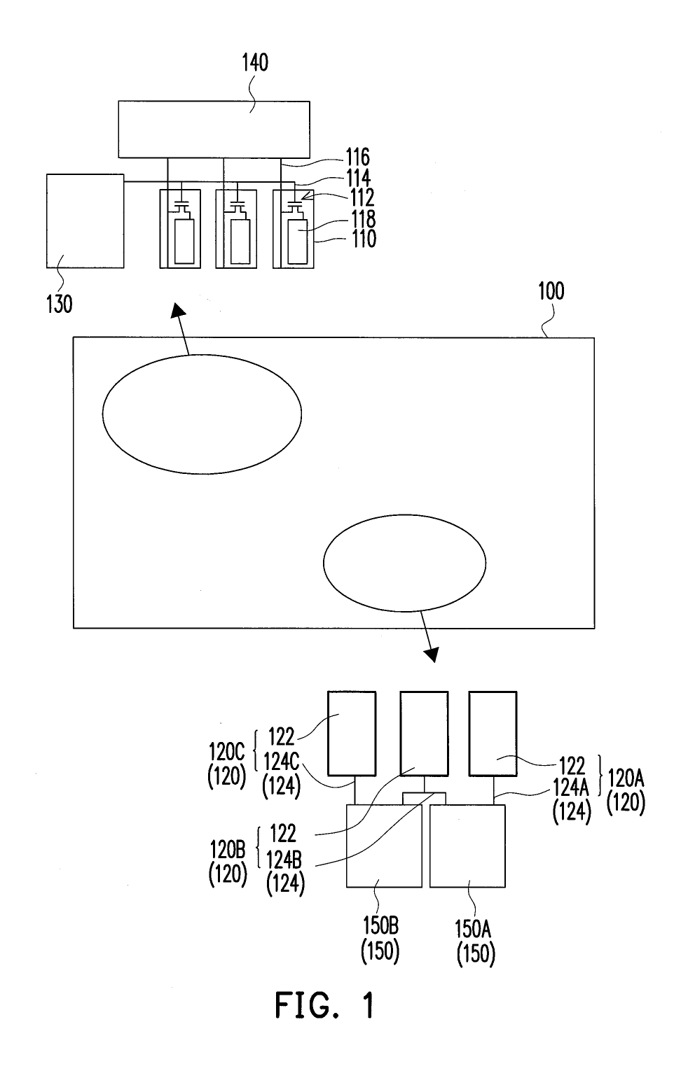

FIG. 1 is a schematic diagram of a touch-sensing display panel according to an exemplary embodiment of the invention. Referring to FIG. 1, a touch-sensing panel 100 includes at least two display units 110, at least two touch-sensing units 120, at least a gate driver circuit 130, at least a data driver circuit 140, and at least two readout circuits 150. Each display unit 110 includes at least a switching element 112, a gate line 114, a data line 116, and a pixel electrode 118. The switching element 112 is connected to the gate line 114, the data line 116, and the pixel electrode 118. The gate driver circuit 130 is electrically connected to the gate line 114 of each display unit 110. The data driver circuit 140 is electrically connected to the data line 116 of each display unit 110. Moreover, in order to achieve the display function, the touch-sensing display panel 100 further includes a display medium layer (not shown) disposed on the pixel electrode 118, and the material of the display medium (not shown) includes, for example, a non-self-luminescent material, a self-luminescent material, or a combination thereof.

In one exemplary embodiment, the display units 110 and the corresponding display medium layer form a display panel, and the touch-sensing units 120 is integrated in the display panel formed with the display units 110. In another exemplary embodiment, the display units 110 and the display medium (not shown) form a display panel, the touch-sensing units 120 form an additional touch-sensing panel, and the touch-sensing display panel 100 is formed by adhering the touch-sensing panel and the display panel together. As shown in FIG. 1, although the display units 110 and the touch-sensing units 120 are respectively depicted by an independent ellipse, the display units 110 and the touch-sensing units 120 may be integrated together to form a touch-sensing display unit, or they may overlap each other in the thickness direction, or respectively configured in different parts of the touch-sensing display panel 100.

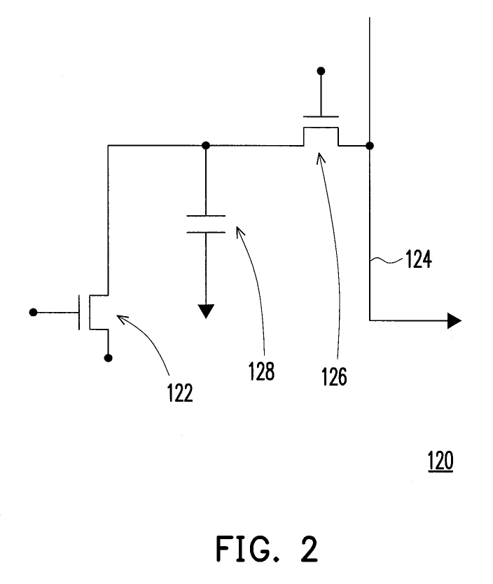

Each touch-sensing unit 120 includes at least a sensing element (or namely sensing device) 122 and a sensing line 124. In the touch-sensing units 120 in this exemplary embodiment, the sensing element 122 includes a resistance sensor, a capacitance sensor, a photosensor, a vibration sensor, electromagnetic sensor, or at least two of the above sensors. The commonly available designs for each type of the sensors are within the scope of the present invention. For example, the circuit diagram of a touch-sensing unit formed with a photosensor is as shown in FIG. 2. The touch-sensing unit 120 may include a sensing element 122, a sensing line 124, a readout device 126, and a storage capacitor 128. The storage capacitor 128 is connected to the readout device 126 and the sensing element 122, and the readout device 126 is also connected to the sensing line 124 of each touch-sensing unit 120. Moreover, the sensing element 122 may be a photosensing transistor, and the readout device 126 may be a transistor. However, it is to be understood that the examples above are presented by way of example and not by way of limitation.

More specifically, the at least two touch-sensing units 120 in this exemplary embodiment include the first touch-sensing units 120A, 120C, and the second touch-sensing unit 120B, wherein the first touch-sensing unit 120A, the second touch-sensing unit 120B, and the first touch-sensing unit 120C are, for example, a plurality of sequentially arranged touch-sensing units 120. Moreover, the at least two readout circuits 150 include the adjacent first readout circuit 150A and second readout circuit 150B. The first sensing line 124A of the first touch-sensing unit 120A is connected to the first readout circuit 150A, the second sensing line 124B of the second touch-sensing unit 120B is connected to the first readout circuit 150A and the second readout circuit 150B concurrently, and the first sensing line 124C of the first touch-sensing unit 120C is connected to the second readout circuit 150B.

Alternatively speaking, the first sensing lines 124A, 124C in this exemplary embodiment are, for example, a one-to-one (or namely one by one) connecting circuit layout, while the second sensing line 124B is, for example, a one-to-two (or one-to-multiple, or namely one by multiple) connecting circuit layout. Additionally, the touch-sensing display panel 100 also includes other additional first touch-sensing units, wherein their designs are similar to those of the first touch-sensing units 120A, 120C, and these additional first touch-sensing units are connected to one of the first readout circuit 150A and the second readout circuit 150B.

When the differential touch-sensing analysis method is used to determine the touched position, the signal difference between the first and the second touch-sensing units 120A, 120B and the signal difference between the second and the first touch-sensing units 120B, 120C must be respectively obtained. Further based on the plurality of signal differences, the position at which the touch-sensing display panel 100 is being touched is determined. However, the differential signal analysis for the plurality of touch-sensing units 120 is not necessary being conducted by a single readout circuit 150. In the current exemplary embodiment, two readout circuits 150 are used to perform the signal analysis on the touch-sensing units 120. Herein, at least a portion of the touch-sensing units 120 (for example, the second touch-sensing unit 120B) is connected to the readout circuit at the pin in the periphery. Assuming the second touch-sensing unit 120B is only connected to the first readout circuit 150A and is not connected to the second readout circuit 150B, certain situations for the touch-sensing display panel 100 may occur as illustrated below.

During the fabrication of the first touch-sensing circuit 150A and the second touch-sensing circuit 150B, abnormal peripheral read signal may occur resulting from the fabrication process (for example, the bonding process). Therefore, when the second touch-sensing unit 120B is only connected to the first readout circuit 150A, the untouched signal of the first and the second touch-sensing units 120A, 120B read by using the first readout circuit 150A may be different from the untouched signal of the first touch-sensing unit 120C read by using the second readout circuit 150B. If for the purpose of performing differential signal analysis, the untouched signal of the second touch-sensing unit 120b read by the first readout circuit 150A is used to calculate the signal difference between the first touch-sensing unit 120C and the second touch-sensing unit 120B, and the position at which the change in the signal difference is determined, an erroneous touch-sensing result is obtained. Moreover, when the second touch sensing unit 120B is only connected to the first readout circuit 150A and is not connected to the second readout circuit 150B, the second readout circuit 150B is unable to read the signal of the second touch-sensing unit 120B, while the signal difference between the second and the first touch-sensing units 120B, 102C is unable to obtain directly from the second readout circuit 150B. Consequently, signal analysis is not continuous.

In this exemplary embodiment, the second touch-sensing unit 120B is concurrently connected to the first readout circuit 150A and the second readout circuit 150B such that the signal difference between the first touch-sensing unit 120C and the second touch-sensing unit 120B may be obtained from the signal read by the same second readout circuit 150B. Accordingly, even the first readout circuit 150A and the second readout circuit 150B have different signal sensing values due to a slight difference in the fabrication processes, the previously mentioned erroneous touch sensing situation is obviated. The second readout circuit 150B may directly read the signals of the second and the first touch-sensing units 120B, 120C such that the signals of the plurality of touch-sensing units 120 are continuously sensed among the different readout circuits 150.

In this exemplary embodiment, one of the touch-sensing units 120 is simultaneously connected to two corresponding readout circuits, and the touch-sensing panel 100 may continuously read the signal differences among these touch-sensing units 120. These signal differences for calculating the touched position are read from the same readout circuits. Accordingly, erroneous sensing resulted from different fabrication processes for the various readout circuits 150 is mitigated and a more accurate touch-sensing result is achieved.

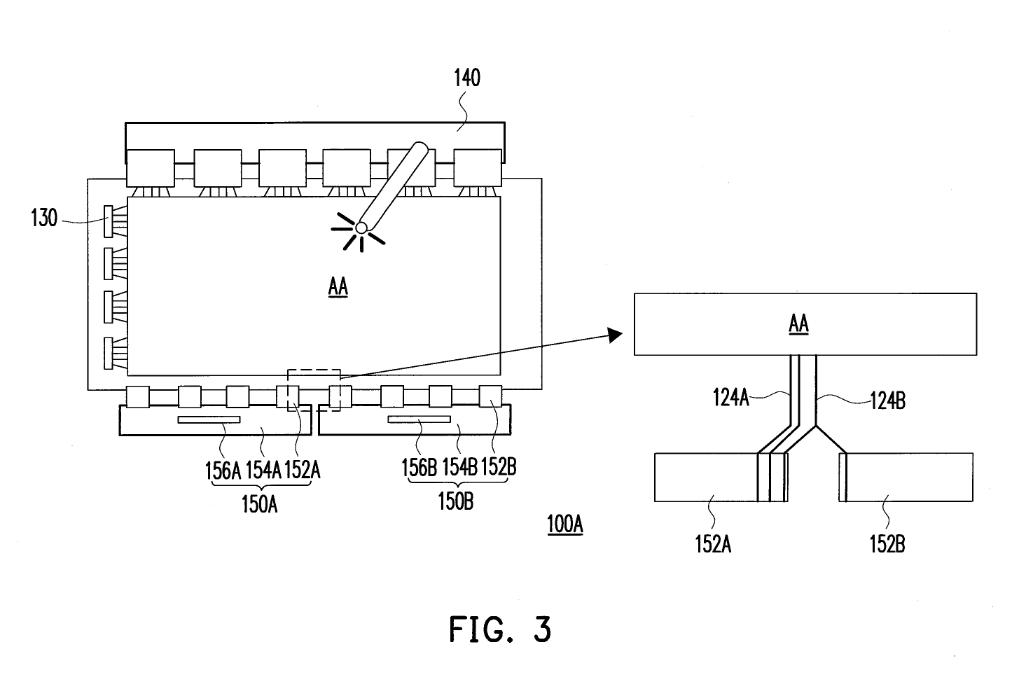

To be more explicitly embody the layout design of the touch-sensing display panel of the invention, a first layout method of a touch-sensing panel of the first exemplary embodiment is presented in FIG. 3, wherein the same reference numbers are used to refer to the same or like part for a portion of the structural component schematically illustrated in FIG. 3 and the structural components illustrated in FIG. 1. It is worthy to note that the display unit and the sensing elements of the touch-sensing units are not explicitly illustrated. However, the designs of the display units and the sensing elements may refer to the technology as shown in FIGS. 1 and 2 or other available technology.

As shown in FIG. 3, the touch-sensing display panel 100A includes an active region AA, wherein the display units and the sensing elements, which are not shown in FIG. 3, may be disposed in the active region, for example. The display units and the touch-sensing units, for example, may be integrated together, mutually stacked together, or respectively disposed in different regions in the active region. The arrangement of each unit or device in the active region is not particularly limited in this exemplary embodiment. Further, in this exemplary embodiment, the first readout circuit 150A includes a first flexible circuit board (or namely FPC) 152A, a first rigid circuit board (or namely printed circuit board, PCB) 154A, and a first touch-sensing circuit chip 156A, wherein the first flexible circuit board 152A is connected between the first rigid circuit board 154A and the active region AA, and the first touch-sensing circuit chip 156A is disposed on the first rigid circuit board 154A. Similarly, the second readout circuit 150 includes a second flexible circuit board 152B, a second rigid circuit board 154B, and a second touch-sensing circuit chip 156B, and the second flexible circuit board 152B is connected between the second rigid circuit board 154B and the active region AA, and the second touch-sensing circuit chip 156B is disposed on the second rigid circuit board 154B.

As shown in the sectional enlarged view of FIG. 3, the second sensing line 124B extends outwardly from the active region AA and is bifurcated into at least two branches to simultaneously connect to the first flexible circuit board 152A of the first readout circuit 150A and the second flexible circuit board 152B of the second readout circuit 150B. However, it is to be understood that the design of the second sensing line 124B having branches is presented by way of example and not by way of limitation. In other exemplary embodiments, the second sensing line 124B may not be bifurcated, but instead includes two lines connecting to the same sensing elements. Additionally, the first and the second touch-sensing circuit chips 156A, 156B are disposed on the first rigid circuit board 154A and the second rigid circuit board 154B to form a touch-sensing circuit chip disposed on a circuit board (Chip-on-board, COB) design. In another embodiment, the first and the second touch-sensing circuit chips 156A, 156B can be disposed on the first flexible circuit board 152A and the second flexible circuit board 152B to form a touch-sensing circuit chip disposed on a flexible circuit board (Chip-on-flexible printed circuit board, COF) design. Alternatively speaking, in other layouts, the first rigid circuit board 154A and the second rigid circuit board 154B may be omitted.

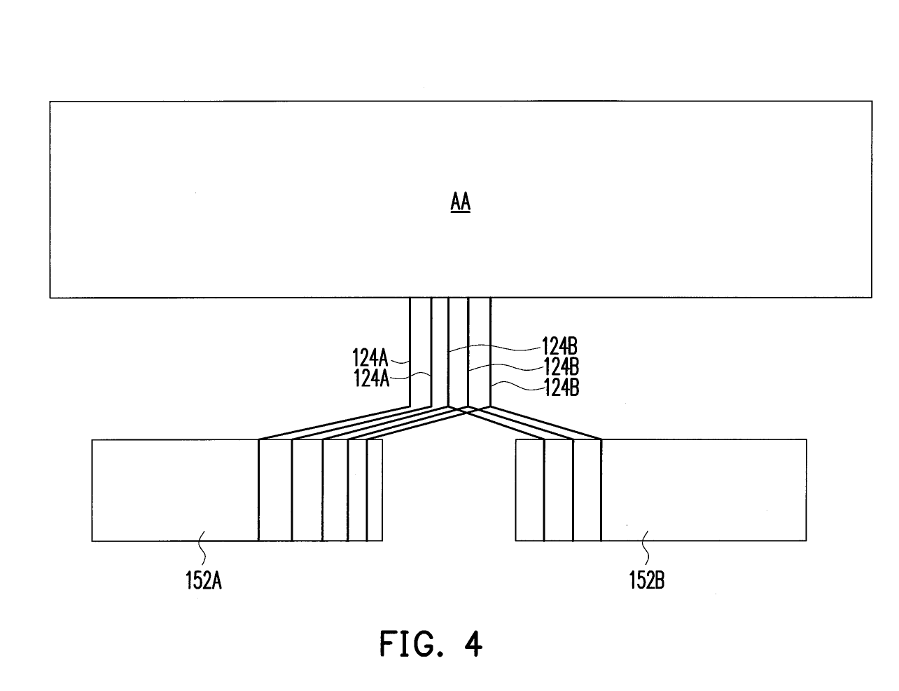

It is worthy to notice that the touch-sensing display panel 100A directly applies the signal difference between two adjacent touch-sensing units to perform the touch-sensing calculation. Hence, among the touch-sensing units, the signal of only one thereof is required to be transmitted to the first readout circuit 150A and the second readout circuit 150B simultaneously. Accordingly, in the plurality of touch-sensing circuit lines that is directly connected to the first readout circuit 150A and the second readout circuit 150B, only one thereof, for example, the second sensing line 124B, is required to have the bifurcation design. However, with the different calculation methods, a multiple of the plurality of touch-sensing circuit lines, which is directly connected to the first readout circuit 150A and the second readout circuit 150B, may be the second sensing line 124B having the bifurcation design, as shown in FIG. 4.

FIG. 4 illustrates an implementation of an active region and readout circuit in a touch-sensing display panel according to an exemplary embodiment of the invention, wherein the structural elements illustrated in FIG. 4 are substantially the same as those illustrated in FIG. 3, and the same reference numbers are used to refer to the same or like part. Referring to FIG. 4, in this exemplary embodiment, the touch-sensing display panel calculates the touch-sensing position by using the signal difference of every other three touch-sensing units. Herein, among the touch-sensing units, the signals of at least three thereof are simultaneously and directly transmitted to two adjacent readout circuits. Hence, the touch-sensing units connected to the first flexible circuit board 152A of the first readout circuit and the second flexible circuit board 152B of the second readout circuit include at least three second touch-sensing units. In other words, at least three second sensing lines 124B from the active region AA are concurrently connected to the first flexible circuit board 152A and the second flexible circuit board 152B. With the various calculation methods, the circuit layout of the touch-sensing panel may be different, wherein the number of the second sensing line 124B may vary according to the touch-sensing calculation method. In a preferred exemplary embodiment, the signal of one of the second sensing lines 124B is substantially different from the signals of the other two sensing lines 124B. In other words, the signal transmitted by each line in the second sensing lines 124B may be selectively substantial the same or different.

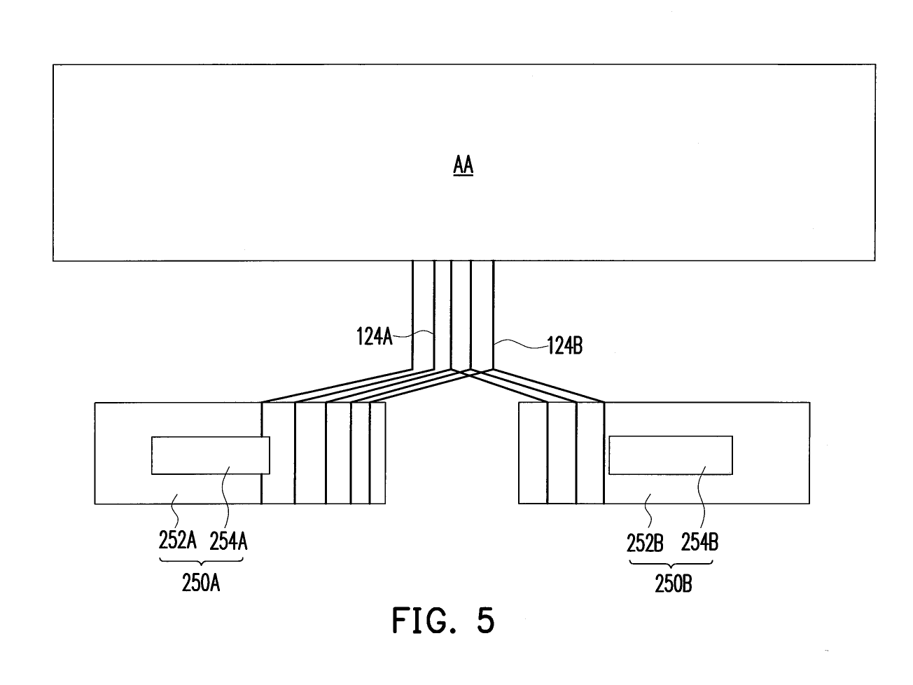

The layouts in FIGS. 3 and 4 are implemented with the COB method for the disposition of the touch-sensing circuit chips 156A, 156B. However, it is to be understood the invention may be realized by using the COF method for the disposition of the touch-sensing circuit chips 156A, 156B. FIG. 5 illustrates an implementation of an active region and a readout circuit in the touch-sensing display panel according to another exemplary embodiment of the invention, wherein the structural elements illustrated in FIG. 5 are substantially the same as those illustrated in FIG. 4, and the same reference numbers are used to refer to the same or like part. Referring to FIG. 5, the difference between the layouts in FIG. 5 and FIG. 4 lies in that the first readout circuit 250A is formed with the first flexible circuit board 252A and the first touch-sensing circuit chip 254A configured on the first flexible circuit board 252A, while the second readout circuit 250B is formed with the second flexible circuit board 252B and the second touch-sensing circuit chip 254B configured on the second flexible circuit board 252B. Herein, both the first readout circuit 250A and the second readout circuit 250B do not include a rigid circuit board. It is to be understood that in the above various layouts, the method of connecting and the application of the flexible circuit board and the rigid circuit board are presented by way of examples and not by way of limitation. Any layout design in which one of the touch-sensing units is simultaneously connected to the two immediately adjacent readout circuits falls within the spirit and scope of the invention. The above disclosure simply refers to certain exemplary embodiments for the purpose of illustrating the concepts of the invention.

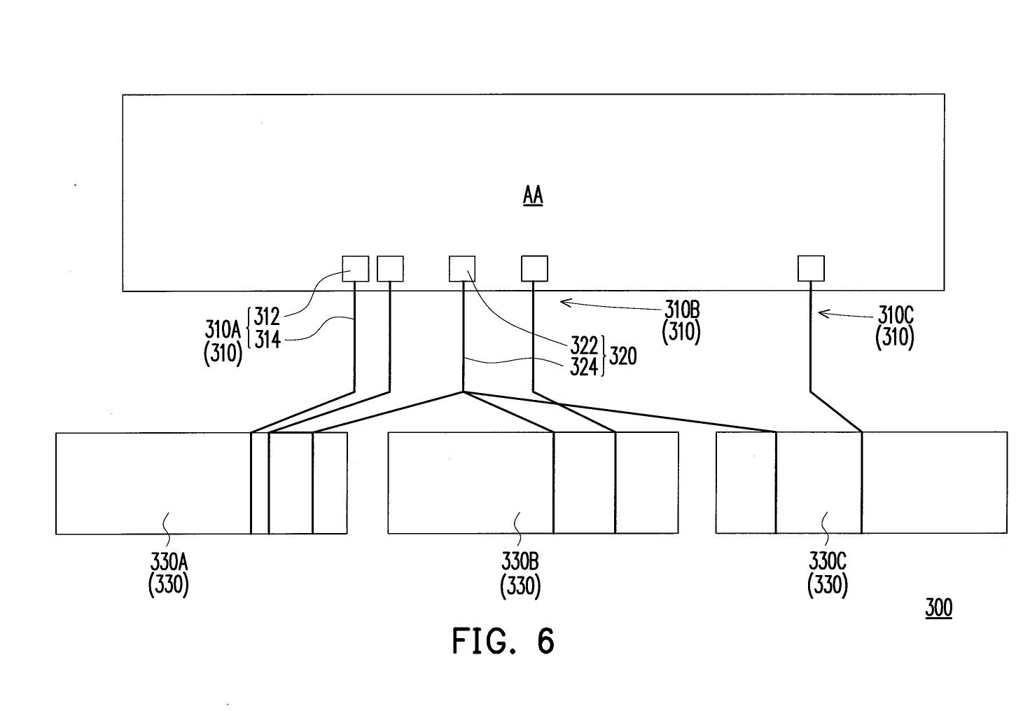

FIG. 6 illustrates the layout method and the design between the active region in a touch-sensing display panel and the readout circuit according to another exemplary embodiment of the invention. The touch-sensing display panel in this exemplary embodiment is similar to the touch-sensing display panel as illustrated in FIG. 1, and at least includes a plurality of display units, a plurality of touch-sensing units, and at least a gate driver circuit, at least a data driver circuit, and a plurality of readout circuits, wherein the numbers of the display units, the touch-sensing units, and the readout circuits are at least three. More specifically, the designs of the display units, the gate driver circuit, the data driver circuit and the cooperative relationships among these structural elements may be referred to the previous descriptions of the above exemplary embodiments. In the current exemplary embodiment, only the designs of the touch-sensing units and the readout circuits are embodied and described herein.

Referring to FIG. 6, the touch-sensing display panel 300 includes at lest three touch-sensing units 310, at least a reference touch-sensing unit 320, and at least three readout circuits 330. Each touch-sensing unit 310 is positioned in the active region AA and includes at least a sensing element 312 and a sensing line 314, and the sensing element 312 is electrically connected to the sensing line 314. The reference touch-sensing unit 320 may also position in the active region AA and at least includes a reference sensing element 322 and a reference sensing line 324, wherein the reference sensing element 322 is electrically connected to the reference sensing line 324. The readout circuit 330 includes the adjacent first readout circuit 330A, second readout circuit 330B, and third readout circuit 330C.

More specifically, the touch-sensing unit 310 may be divided into the first touch-sensing unit 310A, the second touch-sensing unit 310B, and the third touch-sensing unit 310C according the different connected readout circuits. The sensing line 314 of the first touch-sensing unit 310A is connected to the first readout circuit 330A, and the sensing line 314 of the second touch-sensing unit 310B is electrically connected to the second readout circuit 330B, while the sensing line 314 of the third touch-sensing unit 310C is electrically connected to the third readout circuit 330C. Further, the reference sensing line 324 is concurrently connected to the first readout circuit 330A, the second readout circuit 330B, and the third readout circuit 330C. Herein, the first readout circuit 330A, the second readout circuit 330B, and the third readout circuit 330C may be designed, as previously described in the above FIG. 3 or FIG. 5, as a sensing circuit configured on a rigid circuit board or a touch sensing circuit configured on a flexible circuit board. It is to be understood that the examples above are presented by way of example and not by way of limitation.

In the exemplary embodiment, the touch-sensing capability of the reference sensing element 322 in the reference touch-sensing unit 320 is far lower than that of the other sensing element 312. The differentiation of the sensing signal values of the reference sensing element 322 may approach 0. In other words, regardless the sensing element 312 and the reference sensing element 322 are respectively a resistance sensor, a capacitance sensor, a photosensor, a vibration sensor, electromagnetic sensor, or at least include two of the above sensors, the signal of the reference sensing element 322 almost remains unchanged when the touch-sensing display panel is touched. Accordingly, in the touch-sensing display panel 300, each readout circuit 330 may use the signal of the reference sensing element 322 as a reference standard of the untouched signal to determine whether the positions, at where other sensing elements 312 are configured, have been touched or not.

According to the above disclosure, each independent readout circuit 330 may have different touch-sensing sensitivities due to the manufacturing process. Hence, in order to avoid the reference signal of the reference sensing element 322 determined by each readout circuit to be affected by these types of variation, the reference sensing line 324 in this exemplary embodiment may include a plurality of branched circuits allowing the reference sensing element 322 to simultaneously connect to each readout circuit 330. Accordingly, the touch-sensing display panel 300 has the desirable touch-sensing accuracy. It is to be understood that in other exemplary embodiments, a plurality of independent transmission lines may be used to connect between the reference sensing element 322 and each of the readout circuits 330 or other methods are used to simultaneously connect the reference sensing element 322 to all the readout circuits 330.

Although only one reference touch-sensing unit 320 is used to illustrate the exemplary embodiments, it is to be understood that the exemplary embodiments are presented by way of example and not by way of limitation. In other exemplary embodiments, the number of the reference touch-sensing units 320 may be more than one. More particularly, in the touch-sensing display panel 300, asides from having the reference touch-sensing unit 320 to concurrently connect to all the readout circuit 330, a portion of the touch-sensing units 310 may also concurrently connect to the adjacent two readout circuits 330. In other words, the design in this exemplary embodiment may be combined with the design of the previous exemplary embodiments for better enhancing the touch-sensing accuracy of the touch-sensing display panel 300.

Accordingly, the touch-sensing units of the invention are concurrently connected to the adjacent or all the readout circuits. When the touch-sensing display panel uses the differential signal analysis method to determine the touched position, the signal differential value being used is calculated from the signal read by the same touch-sensing circuit chip. Herein, when the signals read by the different readout circuits are different resulted from the manufacturing process, the signal differential value used in the differential signal analysis is not being affected, and the touch-sensing display panel is provided with a better touch-sensing accuracy. Moreover, the touch-sensing display panel may perform the differential signal analysis on the touch-sensing units continuously.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch-sensing display panel comprising:
at least two display units, each of the at least two display units comprising a switching element, a gate line, a data line, and a pixel electrode, and the switching element connected to the gate line, the data line, and the pixel electrode;
at least two touch-sensing units, comprising a first touch-sensing unit and a second touch-sensing unit, each of the at least two touch-sensing units at least comprises a sensing element and a sensing line, and the sensing element electrically connected to the sensing line;
at least a gate driver circuit, electrically connecting to the gate line of the each of the at least two display units;
at least a data driver circuit, electrically connecting to the data line of the each of the at least two display units; and
at least two readout circuits, comprising a first readout circuit and a second readout circuit configured adjacent to each other, wherein the sensing line of the first touch-sensing unit is connected to the first readout circuit, the sensing line of the second touch-sensing unit is concurrently connected to the first readout circuit and the second readout circuit.

2. The touch-sensing display panel of claim 1, wherein each of the at least two readout circuits comprises a flexible circuit board.

3. The touch-sensing display panel of claim 2 further comprising a rigid circuit board and least a sensing integrated circuit (IC), and the rigid circuit board is electrically connected to the flexible circuit board of the each of the at least two readout circuits.

4. The touch-sensing display panel of claim 1, wherein the each of the at least two readout circuits comprises a flexible circuit board and at least a sensing integrate circuit.

5. The touch-sensing display panel of claim 1, wherein the each of the at least two touch-sensing units further comprises a readout element and a storage capacitor connected to the readout element and the sensing element, and the readout element is connected to the sensing line of the each of the at least two touch-sensing units.

6. The touch-sensing display panel of claim 1 further comprising a display medium disposed on the pixel electrode, and a material of the display medium comprises a non-self-luminescent material, a self-luminescent material, or a combination thereof.

7. The touch-sensing display panel of claim 1, wherein the sensing element of the each of the at least two touch-sensing units comprises a resistance sensor, a capacitance sensor, a photosensor, a vibration sensor, electromagnetic sensor, or at least two of the above sensors.

8. A touch-sensing display panel comprising:
at least three display units, each of the at least three display units comprising a switching element, a gate line, a data line, and a pixel electrode, and the switching element connected to the gate line, the data line, and the pixel electrode;
at least three touch-sensing units, comprising a first touch-sensing unit a second touch-sensing unit, and a third touch-sensing unit, each of the at least three touch-sensing units at least comprises a sensing element and a sensing line, and the sensing element electrically connected to the sensing line;
at least a gate driver circuit, electrically connected to the gate line of the each of the at least three display units;
at least a data driver circuit, electrically connected to the data line of the each of the at least three display units;
at least a reference touch-sensing unit, comprising at least a reference sensing element and a reference sensing line, and the reference sensing element electrically connected to the reference sensing line; and
at least three readout circuits, comprising a first readout circuit, a second readout circuit, and a third readout circuit configured adjacent to each other, wherein the sensing line of the first touch-sensing unit is connected to the first readout circuit, the sensing line of the second touch-sensing unit is connected to the second readout circuit, and the sensing line of the third touch-sensing unit is connected to the third readout circuit, and the reference sensing line is concurrently connected to the first readout circuit, the second readout circuit, and the third readout circuit.

9. The touch-sensing display panel of claim 8, wherein each of the at least three readout circuits comprises a flexible circuit board.

10. The touch-sensing display panel of claim 9 further comprising a rigid circuit board and least a sensing integrate circuit (IC), and the rigid circuit board is electrically connected to the flexible circuit board of the each of the at least three readout circuits.

11. The touch-sensing display panel of claim 8, wherein the each of the at least three readout circuits comprises a flexible circuit board and at least a sensing integrate circuit.

12. The touch-sensing display panel of claim 8, wherein the each of the at least three touch-sensing units further comprises a readout element and a storage capacitor connected to the readout element and the sensing element, and the readout element is connected to the sensing line of the each of the at least three touch-sensing units.

13. The touch-sensing display panel of claim 8 further comprising a display medium disposed on the pixel electrode, and a material of the display medium comprises a non-self-luminescent material, a self-luminescent material, or a combination thereof.

14. The touch-sensing display panel of claim 8, wherein the sensing element of the each of the at least three touch-sensing units comprises a resistance sensor, a capacitance sensor, an optical sensor, a vibration sensor, electromagnetic sensor, or at least two of the above sensors.

15. The touch-sensing display panel of claim 8, wherein a sensing capability of the reference sensing element is lower than that of the sensing element of the each of the at least three touch-sensing units.

16. The touch-sensing display panel of claim 15, wherein a differentiation of sensing signal values of the reference sensing element approaches 0.
